(19) United States
(12) Patent Application Publication
(10) Pub. No.: US 2025/0110378 A1
(43) Pub. Date: Apr. 3, 2025

(54) ELECTRO-OPTIC DEVICE COMPRISING A BARRIER LAYER

(71) Applicant: E INK CORPORATION, Billerica, MA (US)

(72) Inventors: Pavel KAMAEV, Lexington, MA (US); David Darrell MILLER, Wakefield, MA (US)

(21) Appl. No.: 18/895,469

(22) Filed: Sep. 25, 2024

Related U.S. Application Data
(60) Provisional application No. 63/541,356, filed on Sep. 29, 2023.

(51) Int. Cl. G02F 1/167; G02F 1/1675; G02F 1/16757

(52) U.S. Cl. CPC G02F 1/167; G02F 1/16757; G02F 2001/1678

(57) ABSTRACT

An electro-optic device is disclosed comprising an electro-optic material layer, a barrier layer that is adjacent to the electro-optic material layer, and an adhesive layer comprising a dopant, wherein the electro-optic material layer, the barrier layer, and the adhesive layer are disposed between two electrode layers. The barrier layer prevents or reduces the diffusion of the dopant and other material from one layer of the electro-optic device to another layer, protecting from degradation of components of the device and enabling good electro-optic performance.

### RELATED APPLICATIONS

This application claims priority to U.S. Provisional Patent Application No. 63/541,356 filed on Sep. 29, 2023, which is incorporated by reference in its entirety, along with all other patents and patent applications disclosed herein.

### BACKGROUND OF THE INVENTION

The present invention relates to electro-optic devices comprising an electro-optic material layer, a barrier layer adjacent to the electro-optic material layer, and an adhesive layer comprising a dopant, wherein the electro-optic material layer, the barrier layer, and the adhesive layer are disposed between two electrode layers. The barrier layer prevents or reduces the diffusion of the dopant and other material from one layer of the electro-optic device to another layer, preserving good electro-optic performance of the electro-optic device.

The term “electro-optic”, as applied to a material or a device or a display or an assembly, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range. The terms “electro-optic device” and “electro-optic display” are herein considered synonymous. The term “electro-optic assembly” as used herein may be an electro-optic device. It may also be a multi-layered component that is used for the construction of the electro-optic device. Thus, for example, a front plane laminate, which will be described below, is also considered an electro-optic assembly.

The term “gray state” is used herein in its conventional meaning in the imaging art to refer to a state intermediate two extreme display states of a pixel and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in display state may not be a color change at all. The terms “black” and “white” may be used hereinafter to refer to the two extreme display states of a display and should be understood as normally including extreme display states which are not strictly black and white, for example the aforementioned white and dark blue states. The term “monochrome” may be used hereinafter to denote a drive scheme that only drives pixels to their two extreme display states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Several types of electro-optic displays are known. One type of electro-optic display is a rotating bichromal member type as described, for example, in U.S. Pat. Nos. 5,808,783; 5,777,782; 5,760,761; 6,054,071; 6,055,091; 6,097,531; 6,128,124; 6,137,467; and 6,147,791. Although this type of display is often referred to as a “rotating bichromal ball” display, the term “rotating bichromal member” is preferred as more accurate since in some of the patents mentioned above the rotating members are not spherical. Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038, 6,870,657, and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a liquid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example, in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT), E Ink Corporation, E Ink California, LLC, and related companies describe various technologies used in encapsulated and microcell electrophoretic and other electro-optic media. Encapsulated electrophoretic media comprise numerous small capsules, each of which itself comprises an internal phase containing electrophoretically mobile particles in a liquid medium, and a capsule wall surrounding the internal phase. Typically, the capsules are themselves held within a polymeric binder to form a coherent layer positioned between two electrodes. In a microcell electrophoretic display, the charged particles and the liquid are not encapsulated within microcapsules but instead are retained within a plurality of cavities formed within a carrier medium, typically a polymeric film. Hereinafter, the term “microcavity electrophoretic display” may be used to cover both encapsulated and microcell electrophoretic displays. The technologies described in these patents and applications include:
(a) Electrophoretic particles, fluids, and fluid additives; see for example U.S. Pat. Nos. 7,002,728 and 7,679,814.
(b) Capsules, binders and encapsulation processes; see for example U.S. Pat. Nos. 6,922,276, 7,184,197, and 7,411,719.
(c) Microcell structures, wall materials, and methods of forming microcells; see for example U.S. Pat. Nos. 7,072,095 and 9,279,906.
(d) Methods for filling and sealing microcells; see for example U.S. Pat. Nos. 7,144,942 and 7,715,088.
(e) Films and sub-assemblies containing electro-optic materials; see for example U.S. Pat. Nos. 6,982,178 and 7,839,564.
(f) Backplanes, adhesive layers and other auxiliary layers and methods used in displays; see for example U.S. Pat. Nos. 7,116,318, 7,535,624, 7,012,735 and 7,173,752.
(g) Color formation and color adjustment; see for example U.S. Pat. Nos. 7,075,502 and 7,839,564.
(h) Methods for driving displays; see for example U.S. Pat. Nos. 7,012,600 and 7,453,445.
(i) Applications of displays; see for example U.S. Pat. Nos. 7,312,784 and 8,009,348.
(j) Non-electrophoretic displays, as described in U.S. Pat. No. 6,241,921 and U.S. Patent Application Publication No. 2015/0277160; and applications of encapsulation and microcell technology other than displays; see for example and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display. In such a display, the electrophoretic medium comprises a plurality of discrete droplets of an electrophoretic liquid and a continuous phase of a polymeric material. The discrete droplets of electrophoretic liquid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light transmissive. See, for example, U.S. Pat. Nos. 5,872,552, 6,130,774, 6,144,361, 6,172,798, 6,271,823, 6,225,971, and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques. Thus, the resulting display can be flexible. Further, because the display medium can be printed using a variety of methods it can be made inexpensively.

Other types of electro-optic materials may also be used in the present invention. Of particular interest, bistable ferroelectric liquid crystal displays (FLC's) are known in the art.

An electrophoretic display typically comprises, in addition to the electro-optic material layer, at least two other layers disposed on opposed sides of the electro-optic material layer. One of these layers is an electrode layer. In most electro-optic devices both these layers are electrode layers, and at least one the electrode layers are patterned to define the pixels of the device. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a light transmissive, single continuous electrode and the other electrode layer is patterned into a matrix of pixel electrodes, each of which defines one pixel of the display. That is, one of the layers is typically an electrically conductive light transmissive layer and the other layer, typically called backplane substrate, comprises a plurality of pixel electrodes configured to apply an electrical potential between the electrically conductive light transmissive layer and the pixel electrodes. In another type of electro-optic device, which is intended for use with a stylus, print head or similar movable electrode separate from the display, only one of the layers adjacent the electro-optic layer comprises an electrode, the layer on the opposed side of the electro-optic layer typically being a protective layer intended to prevent the movable electrode damaging the electro-optic material layer.

The manufacture of a three-layer electro-optic display normally involves at least one lamination operation. For example, in several of the aforementioned MIT and E Ink patents and applications, there is described a process for manufacture an encapsulated electrophoretic display in which an encapsulated electrophoretic medium comprising capsules in a binder is coated on to a flexible substrate comprising indium-tin-oxide (ITO) or a similar electrically conductive coating (which acts as one electrode of the final display) on a plastic film, the capsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. A very similar process can be used to prepare an electrophoretic display usable with a stylus or similar movable electrode by replacing the backplane with a simple protective layer, such as a plastic film, over which the stylus or other movable electrode can slide. In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive. Similar manufacturing techniques can be used with other types of electro-optic displays. For example, a microcell electrophoretic medium or a rotating bichromal member medium may be laminated to a backplane in substantially the same manner as an encapsulated electrophoretic medium.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light transmissive electrically conductive layer; a layer of a solid electro-optic medium; an adhesive layer; and a release sheet. Typically, the light transmissive electrically conductive layer will be carried on a light transmissive substrate, which is preferably flexible, in the sense that the substrate can be manually wrapped around a drum (say) 10 inches (254 mm) in diameter without permanent deformation. The term “light transmissive” is used in this patent and herein to mean that the layer thus designated transmits sufficient light to enable an observer, looking through that layer, to observe the change in display states of the electro-optic medium, which will normally be viewed through the electrically conductive layer and adjacent substrate (if present); in cases where the electro-optic medium displays a change in reflectivity at non-visible wavelengths, the term “light transmissive” should of course be interpreted to refer to transmission of the relevant non-visible wavelengths. The substrate will typically be a polymeric film and will normally have a thickness in the range of about 1 to about 25 mil (25 to 634 μm), preferably about 2 to about 10 mil (51 to 254 μm). The electrically conductive layer is conveniently a thin metal or metal oxide layer of, for example, aluminum or ITO, or it may be an electrically conductive polymer. Poly(ethylene terephthalate) (PET) films coated with aluminum or ITO are available commercially, for example as “aluminized Mylar” (“Mylar” is a Registered Trademark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically conductive layer to the backplane. This process is well adapted to mass production since the front plane laminate may be mass-produced, typically using roll-to-roll coating techniques, and then cut into pieces of any size needed for use with specific backplanes.

U.S. Pat. No. 7,561,324 describes a so-called “double release film” or “double release sheet” which is essentially a simplified version of the front plane laminate of the aforementioned U.S. Pat. No. 6,982,178. One form of the double release film comprises a layer of a solid electro-optic medium sandwiched between two adhesive layers, one or both of the adhesive layers being covered by a release sheet. Another form of the double release film comprises a layer of a solid electro-optic medium sandwiched between two release sheets. Both forms of the double release film are intended for use in a process generally similar to the process for assembling an electro-optic display from a front plane laminate already described, but involving two separate laminations; typically, in a first lamination, the double release film is laminated to a front electrode to form a front sub-assembly, and then, in a second lamination, the front sub-assembly is laminated to a backplane to form the final display, although the order of these two laminations could be reversed, if desired.

As an alternative construction, U.S. Pat. No. 7,839,564 describes a so-called “inverted front plane laminate”, which is a variant of the front plane laminate described in U.S. Pat. No. 6,982,178. This inverted front plane laminate comprises, in order, at least one of a light transmissive protective layer and a light transmissive electrically conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive may or may not be present between the electro-optic layer and a backplane.

Performance criteria of an electro-optic device include consistent performance over time and at various temperatures, image resolution, and device life length. The various layers of an electro-optic device comprise materials having molecules that are relatively small, resulting in their ability to diffuse from one layer to another. This diffusion may result in reduced performance of the device and in reduction of the useful life of the device. For example, electrophoretic displays may include two (or more) different adhesive layers, a first adhesive layer and a second adhesive layer. Typically, the two adhesive layers have different compositions, for example different dopant concentrations. The first adhesive layer may connect the electro-optic material layer with the back electrode, that is, the electrode comprising a plurality of pixel electrodes, whereas the second adhesive composition connects the electro-optic material layer with the front electrode. The second adhesive layer is typically more electrically conductive than the first adhesive layer. That is, typically, the second adhesive layer contains higher concentration of a dopant. It is important that the first adhesive layer does not have high conductivity, because such high conductivity increases the phenomenon of blooming, which negatively affects the image resolution. Blooming is the phenomenon whereby the area of the electro-optic material layer, which changes optical state in response to change of voltage at a pixel electrode, is larger than the pixel electrode itself. If dopant molecules diffuse from the second adhesive layer to the first adhesive layer, the dopant concentration of the first adhesive layer will increase and, as a result, the blooming will increase, reducing the resolution of the device. In general, diffusion of material from one layer of a device to another layer may also degrade other components of the device, reducing its useful life. The inventors of the present invention found that barrier layer of controlled thickness can be effectively formed adjacent to the electro-optic material layer of an electro-optic device. Furthermore, the inventors of the present invention surprisingly found that the presence of a barrier layer adjacent to an electro-optic material layer of an electro-optic device improves low temperature performance of the device. Specifically, it was observed that inventive devices comprising a barrier layer show transitions from one optical state to another optical state with reduced flashing.

### SUMMARY OF THE INVENTION

Aspects of the present invention relate to adhesive compositions and electro-optic assemblies and front plane laminates including these adhesive compositions.

In one aspect, the present invention provides an electro-optic device that can be of type (A) or type (B). The electro-optic device of type (A) comprises, in order, a first light transmissive electrode layer, a barrier layer, an electro-optic material layer, a first adhesive layer, and a second electrode layer. The barrier layer of type (A) electro-optic device is light transmissive. The electro-optic material layer comprises an electrophoretic medium, the electrophoretic medium including charged pigment particles in a non-polar liquid. The first adhesive layer comprises a first dopant having a first concentration. The first dopant may be an ionic liquid. The second electrode layer comprises a plurality of pixel electrodes. The first concentration of the first dopant in the first adhesive layer may be from 50 ppm to 1000 ppm by weight of the first adhesive layer. The first adhesive layer may comprise polyurethane.

The electro-optic device of type (B) comprises, in order, a first light transmissive electrode layer, an electro-optic material layer, a barrier layer, a first adhesive layer, and a second electrode layer. The barrier layer of type (B) electro-optic device does not need to be light transmissive. The electro-optic material layer comprises an electrophoretic medium, the electrophoretic medium including charged pigment particles in a non-polar liquid. The first adhesive layer comprises a first dopant having a first concentration. The first dopant may be an ionic liquid. The second electrode layer comprises a plurality of pixel electrodes. The first concentration of the first dopant in the first adhesive layer may be from 50 ppm to 1000 ppm by weight of the first adhesive layer. The first adhesive layer may comprise polyurethane.

For both type (A) and type (B) electro-optic devices of the present device the electrophoretic medium may be encapsulated in a plurality of microcapsules or in a plurality of microcells. Each microcell comprises partition walls, an opening, and a sealing layer, the sealing layer spanning the opening of each microcell. In electro-optic devices where the electrophoretic medium is encapsulated in a plurality of microcapsules, the electro-optic device may further comprise a second adhesive layer. The second adhesive layer is disposed between the first electrode layer and the barrier layer in the electro-optic device of type (A). The second adhesive layer is disposed between the first electrode layer and the electro-optic material layer in the electro-optic device of type (B). The second adhesive layer may comprise a second dopant having a second concentration. The first dopant may be the same as, or different from the second dopant. The first concentration of the first dopant in the first adhesive layer may be lower than the concentration of the second concentration of the second dopant in the second adhesive layer. The second concentration of the second dopant in the second adhesive layer may be from 1000 ppm to 5000 ppm by weight of the first adhesive layer. The second dopant may be an ionic liquid. The second adhesive layer may comprise polyurethane.

The barrier layer may be formed via sputtering or chemical vapor deposition. The average thickness of the barrier layer may be from 5 nm to 200 nm. The barrier layer may comprise a material selected from the group consisting of silicon dioxide, aluminum oxide, aluminum nitride, titanium nitride, titanium oxide, silicon nitride, indium-tungsten oxide, a metal, and mixtures thereof. If the barrier layer comprises a metal, the metal may be iron, titanium, germanium, vanadium, tungsten, silicon, silver, nickel, niobium, chromium, gold, and mixtures thereof. If the barrier layer comprises a metal, the average thickness of the barrier layer may be from 5 nm to 30 nm.

In another aspect, the present invention provides an electro-optic assembly comprising, in order, a first substrate, a first light transmissive electrode layer, a barrier layer, an electro-optic material layer, a first adhesive layer comprising a first dopant having a first concentration, and a release sheet. The barrier layer is light transmissive.

In another aspect, the present invention provides an electro-optic assembly comprising, in order, a first release sheet, a second adhesive layer comprising a second dopant having a second concentration, a barrier layer, an electro-optic material layer, a first adhesive layer comprising a first dopant having a first concentration, and a second release sheet. The barrier layer is light transmissive.

In another aspect, the present invention provides an electro-optic assembly comprising, in order, a first substrate, a first light transmissive electrode layer, an electro-optic material layer, a barrier layer, a first adhesive layer comprising a first dopant having a first concentration, and a release sheet. The barrier layer may be light transmissive or non-light transmissive.

In another aspect, the present invention provides an electro-optic assembly comprising, in order, a first release sheet, a second adhesive layer comprising a second dopant having a second concentration, an electro-optic material layer, a barrier layer, a first adhesive layer comprising a first dopant having a first concentration, and a second release sheet. The barrier layer may be light transmissive or not light transmissive.

In another aspect, the present invention provides a method of manufacture of an electro-optic device comprising the steps: (a) providing a first electrode layer having a surface, the first electrode layer comprising a light transmissive electrode; (b) coating an electro-optic material slurry onto the surface of the first electrode layer, the electro-optic material slurry comprising a plurality of microcapsules and a binder, each of the plurality of the microcapsules comprising charged particles in a non-polar liquid; (c) curing the binder to form an electro-optic material layer on the surface of the first electrode layer; (d) forming a barrier layer onto the electro-optic via sputtering or via chemical vapor deposition of a barrier material; (e) coating a first adhesive composition onto the barrier layer; (f) curing the adhesive composition, creating a first adhesive layer; (g) attaching a first release sheet onto the first adhesive layer, (h) providing a second electrode comprising a plurality of pixel electrodes; removing the first release sheet, exposing a surface of the first adhesive layer; (i) attaching the second electrode onto the first adhesive layer; (j) providing a first light transmissive electrode; (k) removing the second release sheet, exposing a surface of the second adhesive layer; (i) attaching the first light transmissive electrode onto the first adhesive layer.

In another aspect, the present invention provides a method of manufacture of an electro-optic device comprising the steps: (a) providing a first electrode layer having a surface, the first electrode layer comprising a light transmissive electrode; (b) forming a barrier layer onto the surface of the first electrode layer via sputtering or via chemical vapor deposition of a barrier material; (c) coating an electro-optic material slurry onto the barrier layer, the electro-optic material slurry comprising a plurality of microcapsules and a binder, each of the plurality of the microcapsules comprising charged particles in a non-polar liquid; (d) curing the binder to form an electro-optic material layer on the surface of the first electrode layer; (e) coating a first adhesive composition onto the electro-optic material layer; (f) curing the adhesive composition, creating a first adhesive layer; (g) attaching a first release sheet onto the first adhesive layer; (h) providing a second electrode comprising a plurality of pixel electrodes; removing the first release sheet, exposing a surface of the first adhesive layer; (i) attaching the second electrode onto the first adhesive layer; (j) providing a first light transmissive electrode; (k) removing the second release sheet, exposing a surface of the second adhesive layer; (i) attaching the first light transmissive electrode onto the first adhesive layer.

In yet another aspect, the present invention provides a method of manufacture of an electro-optic device comprising the steps: (a) providing a third release sheet; (b) coating an electro-optic material slurry onto the third release sheet, the slurry comprising a plurality of microcapsules and a binder, each of the plurality of the microcapsules comprising charged particles in a non-polar liquid; (c) curing the electro-optic material slurry to form an electro-optic material layer on the third release sheet; (d) forming a barrier layer onto the electro-optic material layer via sputtering or via chemical vapor deposition of a barrier material to form an electro-optic material film comprising, in order, the barrier layer, the electro-optic material layer, and the third release sheet; (e) providing a second release sheet; (f) coating a second adhesive composition onto the second release sheet; (g) curing the second adhesive composition, creating a second adhesive layer; (h) attaching a fourth release sheet onto the first adhesive layer to form a second release structure comprising, in order, a fourth release sheet, a second adhesive layer, and a second release sheet; (i) removing the fourth release sheet from the second release structure, exposing a surface of the second adhesive layer of the second release structure; (j) connecting the exposed surface of the second adhesive layer onto the barrier layer of the electro-optic material film to form an intermediate electro-optic structure comprising, in order, the second release sheet, the second adhesive layer, the barrier layer, the electro-optic material layer, and the third release sheet; (k) providing a first release sheet; (l) coating a first adhesive composition onto the first release sheet; (m) curing the first adhesive composition, creating a first adhesive layer, to form a first release structure comprising the first adhesive layer and the first release sheet; (n) removing the third release sheet from the intermediate electro-optic structure to expose a surface of the electro-optic material layer; (o) connecting the exposed surface of the electro-optic material layer onto the first adhesive layer of the first release structure, to form a double release sheet; (p) providing a second electrode; (q) removing the first release sheet of the double release sheet to expose a surface of the first adhesive layer; (r) connecting the exposed surface of the first adhesive layer with the second electrode to form an intermediate electro-optic web; (s) providing a first light transmissive electrode; (t) removing the second release sheet of the intermediate electro-optic web, exposing a surface of the second adhesive layer, (u) connecting the exposed surface of the second adhesive layer with the first light transmissive electrode.

In yet another aspect, the present invention provides a method of manufacture of an electro-optic device comprising the steps: a method of manufacture an electro-optic device, the process comprising the steps: (a) providing a third release sheet; (b) coating an electro-optic material slurry onto the third release sheet, the slurry comprising a plurality of microcapsules and a binder, each of the plurality of the microcapsules comprising charged particles in a non-polar liquid; (c) curing the electro-optic material slurry to form an electro-optic material layer on the third release sheet; (d) forming a barrier layer onto the electro-optic material layer via sputtering or via chemical vapor deposition of a barrier material to form an electro-optic material film comprising, in order, the barrier layer, the electro-optic material layer, and the third release sheet; (e) providing a first release sheet; (f) coating a first adhesive composition onto the first release sheet; (g) curing the first adhesive composition, creating a first adhesive layer; (h) attaching a fourth release sheet onto the first adhesive composition to form a first release assembly comprising, in order, a fourth release sheet, a first adhesive layer, and a first release sheet; (i) removing the fourth release sheet from the first release assembly, exposing a surface of the first adhesive layer; (j) connecting the exposed surface of the first adhesive layer onto the barrier layer of the electro-optic material film to form an intermediate electro-optic assembly comprising, in order, the first release sheet, the first adhesive layer, the barrier layer, the electro-optic material layer, and the third release sheet; (k) providing a second release sheet; (l) coating a second adhesive composition onto the second release sheet; (m) curing the second adhesive composition, creating a second adhesive layer, to form a second release assembly comprising the second adhesive layer and the second release sheet; (n) removing the third release sheet from the intermediate electro-optic assembly to expose a surface of the electro-optic material layer; (o) connecting the exposed surface of the electro-optic material layer of the intermediate electro-optic assembly onto the second adhesive composition of the second release assembly, to form a double release film; (p) providing a second electrode; (q) removing the first release sheet of the double release film to expose a surface of the first adhesive layer; (r) connecting the exposed surface of the first adhesive layer with the second electrode to form an intermediate electro-optic device; (s) providing a first light transmissive electrode; (t) removing the second release sheet of the intermediate electro-optic device, exposing a surface of the second adhesive layer; (u) connecting the exposed surface of the second adhesive layer with the first light transmissive electrode.

### BRIEF DESCRIPTION OF DRAWINGS

Various aspects and embodiments of the application will be described with reference to the following figures. It should be appreciated that the figures are not necessarily drawn to scale.

FIG. 1 is a schematic illustration of a side view of a type (B) electro-optic device of the present invention; the device comprises a barrier layer, the barrier layer being located between the electro-optic material layer and the first adhesive layer, the first adhesive layer being adjacent to the backplane. The device can be manufactured via a front plane laminate assembly. The electro-optic material layer comprises electrophoretic medium encapsulated in microcapsules.

FIG. 2 is a schematic illustration of a side view of an electro-optic assembly (front plane laminate) comprising a barrier layer, the barrier layer being located between the electro-optic material layer and the first adhesive layer, the first adhesive layer being adjacent to the release sheet. The electro-optic material layer comprises electrophoretic medium encapsulated in microcapsules.

FIG. 3 is a schematic illustration of a side view of a type (B) electro-optic device of the present invention; it comprises a barrier layer, the barrier layer being located between the electro-optic material layer and the first adhesive layer, the first adhesive layer being adjacent to the backplane. The device can be manufactured via a double release film, the double release film having two adhesive layers. The electro-optic material layer comprises electrophoretic medium encapsulated in microcapsules.

FIG. 4 is a schematic illustration of a side view of an electro-optic assembly (double release film) comprising a barrier layer, the barrier layer being located between the electro-optic material layer and the first adhesive layer, the first adhesive layer being adjacent to the first release sheet. The double release film has two adhesive layers. The electro-optic material layer comprises electrophoretic medium encapsulated in microcapsules.

FIG. 5 is a schematic illustration of a side view of a type (A) electro-optic device of the present invention; it comprises a barrier layer, the barrier layer being located between the electro-optic material layer and the second adhesive layer, the second adhesive layer being adjacent to the first light transmissive electrode, which is near the viewing side of the device. The device can be manufactured via a front plane laminate assembly. The electro-optic material layer comprises electrophoretic medium encapsulated in microcapsules.

FIG. 6 is a schematic illustration of a side view of an electro-optic assembly (front plane laminate) comprising a barrier layer, the barrier layer being located between the electro-optic material layer and the second adhesive layer, the second adhesive layer being adjacent to the second release sheet. The electro-optic material layer comprises electrophoretic medium encapsulated in microcapsules.

FIG. 7 is a schematic illustration of a side view of a type (A) electro-optic device of the present invention; it comprises a barrier layer, the barrier layer being located between the electro-optic material layer and the second adhesive layer, the second adhesive layer being adjacent to the first light transmissive electrode, which is near the viewing side of the device. The device can be manufactured via a double release film, the double release film having two adhesive layers. The electro-optic material layer comprises electrophoretic medium encapsulated in microcapsules.

FIG. 8 is a schematic illustration of a side view of an electro-optic assembly (double release film) comprising a barrier layer, the barrier layer being located between the electro-optic material layer and the second adhesive layer, the second adhesive layer being adjacent to the second release sheet. The electro-optic material layer comprises electrophoretic medium encapsulated in microcapsules.

FIG. 9 is a schematic illustration of a side view of a type (A) electro-optic device of the present invention; it comprises a barrier layer, the barrier layer being located between the electro-optic material layer and the first adhesive layer, the first adhesive layer being adjacent to the backplane. The electro-optic material layer comprises electrophoretic medium encapsulated in microcells.

FIGS. 10A and 10B illustrate an example of a method of manufacture of the electro-optic device of FIG. 1.

FIGS. 11A and 11B illustrate an example of a method of manufacture of the electro-optic device of FIG. 5.

FIGS. 12A, 12B, 12C, 12D, 13A, and 13B illustrate an example of a method of manufacture of the electro-optic device of FIG. 3.

FIGS. 14A, 14B, 14C, 14D, 15A and 15B illustrate an example of a method of manufacture of the electro-optic device of FIG. 7.

FIG. 16 is an Electrical Impedance Spectrum of a control electro-optic device, which does not contain a barrier layer.

FIG. 17 is an Electrical Impedance Spectrum of an inventive electro-optic device, which contains a barrier layer.

FIG. 18 shows the equivalent circuit elements used for the model used for the analysis of the Electrochemical Impedance Spectroscopy of Control and Inventive Devices of the Examples.

Other aspects, embodiments and features of the invention will become apparent from the following detailed description when considered in conjunction with the accompanying drawings.

### DETAILED DESCRIPTION OF THE INVENTION

The present invention has a number of different aspects, which will be described below. It should be recognized that a single electro-optic device or component thereof may make use of multiple aspects of the present invention.

The electro-optic device of the present invention may be an electrophoretic display.

Before describing the various aspects of the present invention it is useful to set out certain definitions.

The term “light transmissive” referring to a layer, such as a barrier layer or an electrode layer, means that the layer thus designated transmits sufficient light to enable an observer, looking through that layer, to observe the change in display states of the electrophoretic medium, which will be normally viewed through the first electrode layer and adjacent substrate, if present.

The term “light transmissive electrode layer” is used consistent with its conventional meaning in the art of electro-optic displays and in the aforementioned patents and published applications, to mean a rigid or flexible material that is light transmissive. The light transmissive electrode layer comprises most commonly a single continuous electrode (comprising an electrically conductive material) extending across the entire display viewing side. Typically, the surface of the light transmissive electrode layer that is visible to an observer forms the viewing surface through which the observer views the display, although there may be additional layers interposed between the front substrate and the viewing surface. As with the backplane, the front substrate should provide sufficient barrier properties to prevent ingress of moisture and other contaminants through the viewing side of the display.

The term “viewing side” or “viewing surface” of an electrophoretic display is the side of the electrophoretic display on which the image is displayed and can be viewed by a viewer. A typical electro-optic device has two sides, the viewing side and a back side. However, an electro-optic device may have two viewing sides.

The term “conductive” as used herein for a material or a layer or a seal refers to “electrically conductive” material or a layer or a seal, unless otherwise mentioned.

The term “backplane” is used herein consistent with its conventional meaning in the art of electro-optic devices and in the aforementioned patents and published applications, to mean a rigid or flexible material comprising an electrode layer having one or more electrodes. The backplane may also be provided with electronics for addressing the display, or such electronics may be provided in a unit separate from the backplane. In flexible displays, it is highly desirable that the backplane provides sufficient barrier properties to prevent ingress of moisture and other contaminants through the non-viewing side of the display (the display is of course normally viewed from the side remote from the backplane).

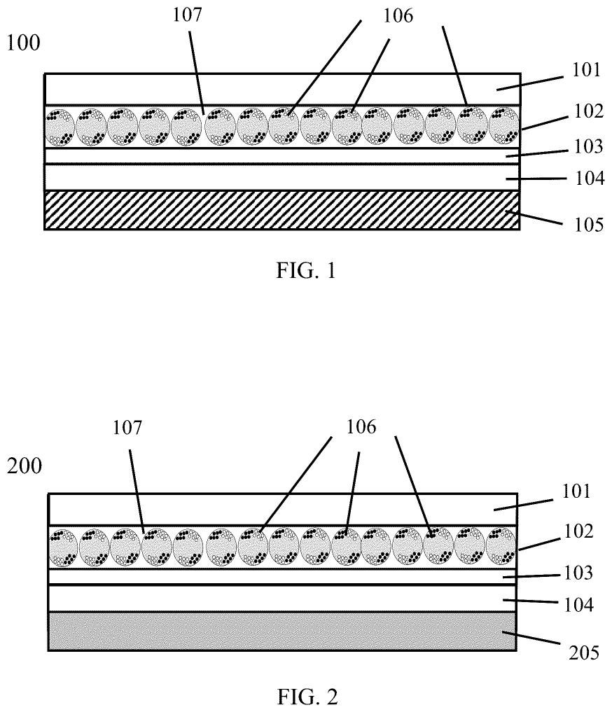

The present invention improves the performance and lifespan of electro-optic devices. Examples of such devices are illustrated in FIGS. 1 to 9.

FIG. 1 is a schematic illustration of a side view of an example of a type (B) inventive electro-optic device comprising a barrier layer. The electro-optic device 100 of FIG. 1 comprises a first light transmissive electrode layer 101, an electro-optic material layer 102, a barrier layer 103, a first adhesive layer 104, and a second electrode layer 105, second layer 105 comprising a plurality of pixel electrodes. The electro-optic device may further comprise a first substrate or supporting layer (not shown in FIG. 1). The substrate is located adjacent to first light transmissive electrode layer 101, so that the first light transmissive electrode layer 101 is disposed between the first substrate and the electro-optic material layer 102. The substrate may be a polymeric film or a glass substrate that supports the first light transmissive electrode layer and protects it from mechanical damage. Barrier layer 103 is adjacent to and in contact with electro-optic material layer 102. Electro-optic material layer 102 may comprise electrophoretic medium, which is encapsulated in a plurality of microcapsules 106. That is, each microcapsule 106 includes one or more types of charged pigment particles in a non-polar liquid. The plurality of charged particles may be caused to move upon application of an electric field via the first light transmissive electrode and the second electrode layer. Each of the plurality of capsules 106 may comprise a plurality of a first type of charged particles and a plurality of a second type of charged particles in a non-polar liquid. Each of the plurality of capsules 106 may further comprise a plurality of a third first type of charged particles and a plurality of a fourth type of charged particles in the non-polar liquid. Electro-optic material layer 102 further comprises a binder 107. Typically, the electro-optic material layer is formed by a slurry (or dispersion) comprising the capsules and the binder in a liquid. Specifically, the slurry is coated on a layer and cured to form the electro-optic material layer. The curing of the slurry can take place thermally or via UV irradiation. Application of an electric field via the two electrode layers produces an image.

The electro-optic device 100 of FIG. 1 can be manufactured from an electro-optic assembly 200, shown in FIG. 2. This assembly is a Front Plane Laminate (FPL) and comprises transmissive electrode layer 101, electro-optic material layer 102, barrier layer 103, a first adhesive layer 104, and a release sheet 205. The electro-optic assembly 200 may further comprise a first substrate (not shown in FIG. 2). The substrate is located adjacent to first light transmissive electrode layer 101, so that the first light transmissive electrode layer 101 is disposed between the first substrate and the electro-optic material layer 102. Removal of first release sheet 205 exposes a surface of adhesive layer 104. Attachment of a second electrode layer on the exposed surface of first adhesive layer 104 forms type (B) electro-optic device 100 of FIG. 1. The second electrode may be part of a more complex assembly that comprises circuitry and a substrate, typically called backplane.

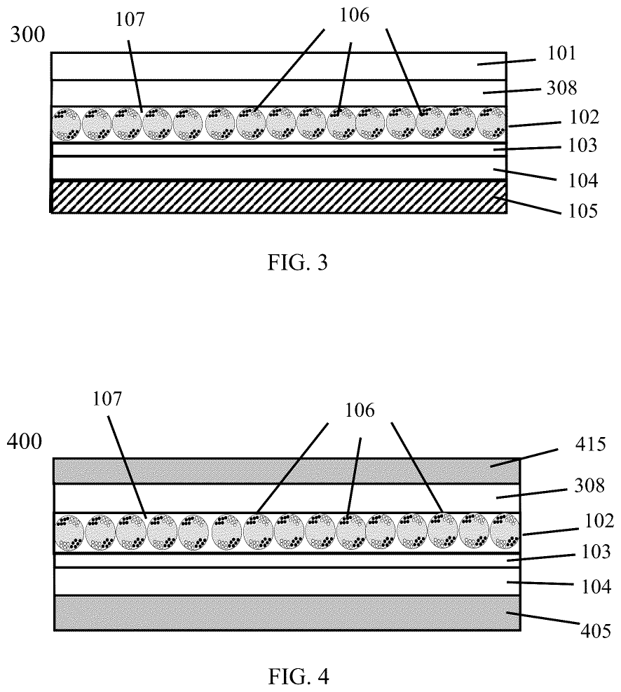

In some embodiments, the electro-optic device may comprise more than one adhesive layers, as illustrated in the device 300 of FIG. 3. FIG. 3 is a schematic illustration of a side view of another example of a type (B) inventive electro-optic device comprising a barrier layer. The electro-optic device 300 of FIG. 3 comprises a first light transmissive electrode layer 101, a second adhesive layer 308, an electro-optic material layer 102, a barrier layer 103, a first adhesive layer 104, and a second electrode layer 105, second layer 105 comprising a plurality of pixel electrodes. The electro-optic device may further comprise a first substrate (not shown in FIG. 3). The substrate is located adjacent to first light transmissive electrode layer 101, so that the first light transmissive electrode layer 101 is disposed between the first substrate and the electro-optic material layer 102. Barrier layer 103 is adjacent to and in contact with electro-optic material layer 102. Electro-optic material layer 102 may comprise electrophoretic medium, which is encapsulated in a plurality of microcapsules 106. That is, each microcapsule 106 includes one or more types of charged pigment particles in a non-polar liquid. Electro-optic material layer 102 further comprises a binder 107. Second adhesive layer 308 may comprise a different adhesive from the adhesive of first adhesive layer 104. Second adhesive layer 308 may comprise the same adhesive as adhesive of first adhesive layer 104. Furthermore, first adhesive layer 104 may comprise a dopant having a first concentration and second adhesive layer 308 may comprise a dopant having a second concentration. The second dopant concentration in second adhesive layer 308 may be higher than the first dopant concentration in first adhesive layer 104.

The electro-optic device 300 of FIG. 3 can be manufactured from an electro-optic assembly 400, shown in FIG. 4. This assembly is a Double Release Film (DRF) and comprises a second release film 415, a first adhesive layer 308, an electro-optic material layer 102, a barrier layer 103, a first adhesive layer 104, and a first release sheet 205. Removal of first release sheet 205 exposes a surface of adhesive layer 104. Attachment of a second electrode layer comprising a plurality of pixel electrodes on the exposed surface of first adhesive layer 104 forms an intermediate electro-optic device. Then, removal of first release sheet 205 exposes a surface of second adhesive layer 308. Attachment of a first light transmissive electrode on the exposed surface of second adhesive layer 304 forms electro-optic device 300, which is shown in FIG. 3.

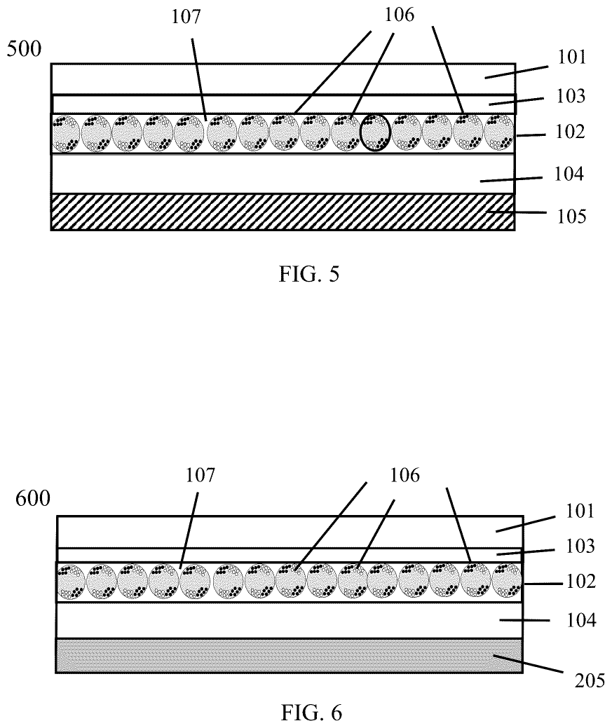

FIG. 5 is a schematic illustration of a side view of an example of a type (A) inventive electro-optic device comprising a barrier layer. The electro-optic device 500 of FIG. 5 comprises a first light transmissive electrode layer 101, a barrier layer 103, an electro-optic material layer 102, a first adhesive layer 104, and a second electrode layer 105, second layer 105 comprising a plurality of pixel electrodes. The electro-optic device may further comprise a first substrate (not shown in FIG. 5). The substrate is located adjacent to first light transmissive electrode layer 101, so that the first light transmissive electrode layer 101 is disposed between the first substrate and the electro-optic material layer 102. Barrier layer 103 is adjacent to and in contact with electro-optic material layer 102. Electro-optic material layer 102 may comprise electrophoretic medium, which is encapsulated in a plurality of microcapsules 106. That is, each microcapsule 106 includes one or more types of charged pigment particles in a non-polar liquid. Electro-optic material layer 102 further comprises a binder 107.

The electro-optic device 500 of FIG. 5 can be manufactured from an electro-optic assembly 600, shown in FIG. 6. This assembly is a Front Plane Laminate (FPL) and comprises transmissive electrode layer 101, a barrier layer 103, electro-optic material layer 102, a first adhesive layer 104, and a release sheet 205. The electro-optic assembly 600 may further comprise a first substrate (not shown in FIG. 6). The substrate is located adjacent to first light transmissive electrode layer 101, so that the first light transmissive electrode layer 101 is disposed between the first substrate and the electro-optic material layer 102. Removal of first release sheet 205 exposes a surface of adhesive layer 104. Attachment of a second electrode layer comprising a plurality of pixel electrodes on the exposed surface of first adhesive layer 104 forms electro-optic device 500 of FIG. 5. The second electrode may be part of a more complex assembly that comprises circuitry and a substrate, typically called backplane.

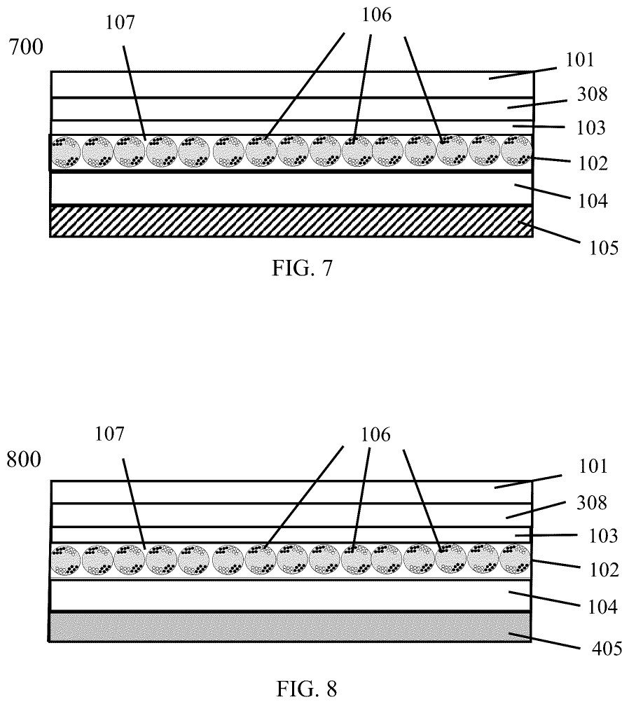

FIG. 7 is a schematic illustration of a side view of another example of a type (A) inventive electro-optic device comprising a barrier layer. The electro-optic device 700 of FIG. 7 comprises a first light transmissive electrode layer 101, a second adhesive layer 308, a barrier layer 103, an electro-optic material layer 102, a first adhesive layer 104, and a second electrode layer 105, second layer 105 comprising a plurality of pixel electrodes. The electro-optic device may further comprise a first substrate (not shown in FIG. 7). The substrate is located adjacent to first light transmissive electrode layer 101, so that the first light transmissive electrode layer 101 is disposed between the first substrate and the barrier layer 103. Barrier layer 103 is adjacent to and in contact with electro-optic material layer 102. Electro-optic material layer 102 may comprise electrophoretic medium, which is encapsulated in a plurality of microcapsules 106. That is, each microcapsule 106 includes one or more types of charged pigment particles in a non-polar liquid. Electro-optic material layer 102 further comprises a binder 107.

The electro-optic device 700 of FIG. 7 can be manufactured from an electro-optic assembly 800, shown in FIG. 8. This assembly is a Double Release Film (DRF) and comprises a second release film 415, a first adhesive layer 308, a barrier layer 103, an electro-optic material layer 102, a first adhesive layer 104, and a first release sheet 205. Removal of first release sheet 205 exposes a surface of adhesive layer 104. Attachment of a second electrode layer comprising a plurality of pixel electrodes on the exposed surface of first adhesive layer 104 forms an intermediate electro-optic device. Then, removal of first release sheet 205 exposes a surface of second adhesive layer 308. Attachment of a first light transmissive electrode on the exposed surface of second adhesive layer 304 forms electro-optic device 700, which is shown in FIG. 7.

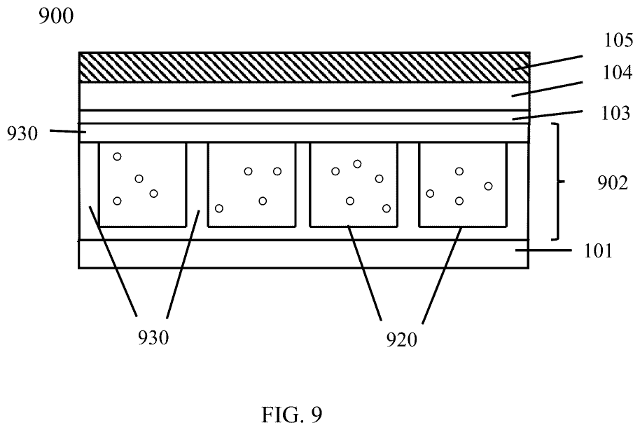

FIG. 9 is a schematic illustration of a side view of another example of a type (A) inventive electro-optic device comprising a barrier layer. The electro-optic device 900 of FIG. 9 comprises a first light transmissive electrode layer 101, an electro-optic material layer 902, a first adhesive layer 104, and a second electrode layer 105, second layer 105 comprising a plurality of pixel electrodes. The electro-optic device may further comprise a first substrate (not shown in FIG. 9). The substrate is located adjacent to first light transmissive electrode layer 101, so that the first light transmissive electrode layer 101 is disposed between the first substrate and the electro-optic material layer 902. Barrier layer 103 is adjacent to and in contact with electro-optic material layer 902. Electro-optic material layer 902 may comprise electrophoretic medium, which is encapsulated in a plurality of microcells 920. Each microcell comprises partition walls 930. Each microcell has an opening, which is sealed by a sealing layer 930. That is, sealing layer 930 spans the opening of each microcell.

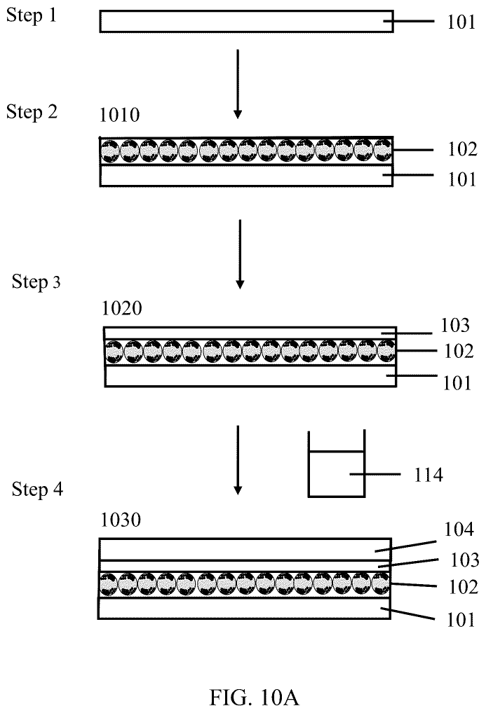

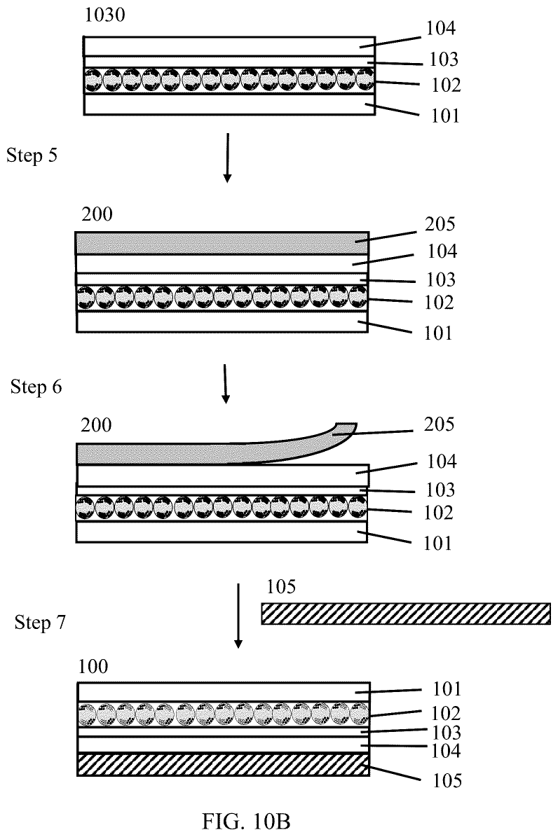

FIGS. 10A and 10B summarize an example of the method of manufacture of type (B) electro-optic device 100 via electro-optic assembly 200 (front plane laminate). Steps 1 to 4 are summarized in FIG. 10A, and steps 5-7 are summarized in FIG. 10B. In Step 1 of the method of manufacture of electro-optic device 100, a first light transmissive electrode layer 101 is provided. In Step 2, an electro-optic material slurry (not shown in FIG. 10A) is coated onto a surface of first light transmissive electrode layer 101. The electro-optic material slurry is cured to form structure 1010 comprising an electro-optic material layer 102 on first light transmissive layer 101. The electro-optic material slurry comprises a plurality of capsules 106 and a binder 107 in a carrier. Each of the plurality of capsules comprises a plurality of charged particles in a non-polar liquid. The curing of the electro-optic material slurry may be achieved by heating, evaporation or via UV radiation.

In Step 3, a barrier layer 103 is formed onto a surface of electro-optic material layer 102 of structure 1010, forming structure 1020, comprising, in order, first light transmissive layer 101, electro-optic material layer 102, and barrier layer 103.

In Step 4, a first adhesive layer 104 is formed by coating an adhesive composition 114 onto barrier layer 103, followed by curing of the initially formed adhesive coating thermally or via UV irradiation, creating structure 1030, which comprises first light transmissive electrode layer 101, electro-optic material layer 102, barrier layer 103, and first adhesive layer 104.

In Step 5 of the method of manufacture electro-optic device 100, a release sheet is attached onto adhesive layer 104 of structure 1030 to form electro-optic assembly 200, which is a front plane laminate (FPL). In Step 6, removal of release sheet 205 from electro-optic assembly 200 exposes a surface of first adhesive layer 104. In Step 7, attachment of a second electrode layer 105 onto first adhesive layer 104 forms electro-optic device 100. Second electrode layer 105 may be part of a backplane, which can also comprise an electric circuit. That is, backplane comprising second electrode layer 105 may be used in Step 7 of the method of manufacture of electro-optic device 100.

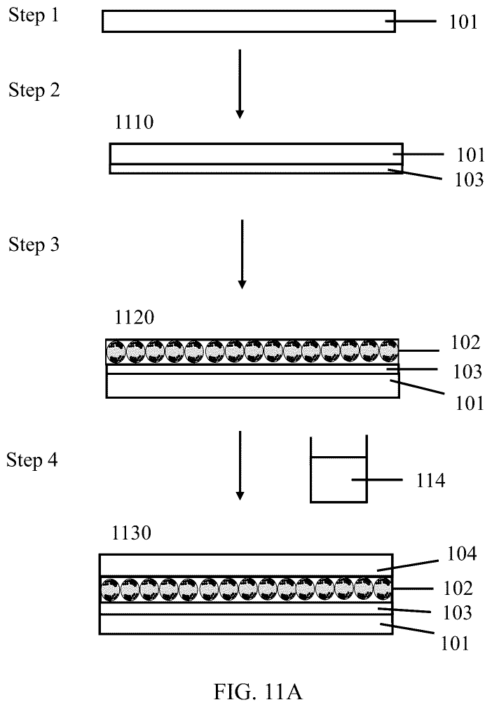

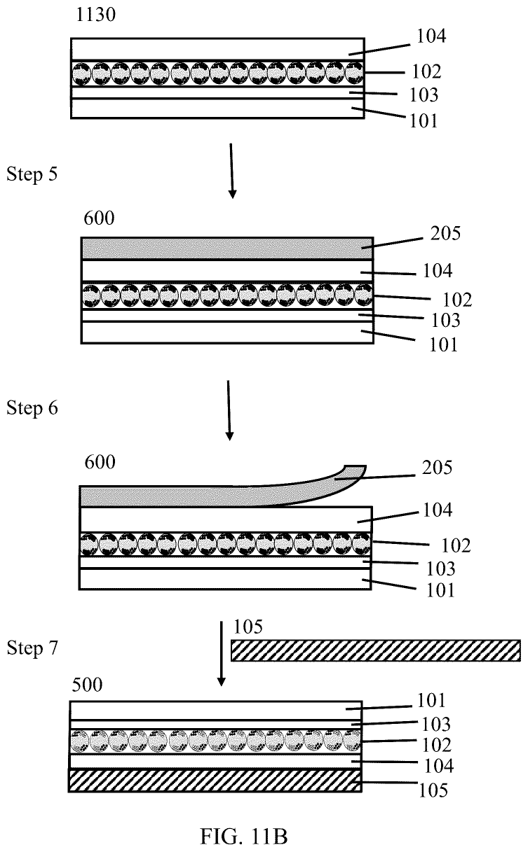

FIGS. 11A and 11B summarize an example of the method of manufacture of type (A) electro-optic device 500 via electro-optic assembly 600 (front plane laminate). Steps 1 to 4 are summarized in FIG. 11A and steps 5-7 are summarized in FIG. 11B. In Step 1 of the method of manufacture of electro-optic device 400, a first light transmissive electrode layer 101 is provided. In Step 2, a barrier layer 103 is formed onto first light transmissive layer 101 to form structure 1110. In step 3, an electro-optic material slurry (not shown in FIG. 11A) is coated onto barrier layer 103 of structure 1110. The electro-optic material slurry is cured to form structure 1120 comprising an electro-optic material layer 102, barrier layer 103, and first light transmissive layer 101. The electro-optic material slurry comprises a plurality of capsules 106 and a binder 107 in a carrier. The curing of the electro-optic material slurry may be achieved by heating, evaporation or via UV radiation.

In Step 4, a first adhesive layer 104 is formed by coating an adhesive composition 114 onto electro-optic material layer 102 of structure 1120, followed by curing of the initially formed adhesive coating thermally or via UV irradiation, creating structure 1130, which comprises first light transmissive electrode layer 101, barrier layer 103, electro-optic material layer 102, and first adhesive layer 104.

In Step 5 of the method of manufacture electro-optic device 500, a release sheet is attached onto adhesive layer 104 of structure 1130 to form electro-optic assembly 600, which is a front plane laminate (FPL). In Step 6, removal of release sheet 205 from electro-optic assembly 600 exposes a surface of first adhesive layer 104. In Step 7, attachment of a second electrode layer 105 onto first adhesive layer 104 forms electro-optic device 500. Second electrode layer 105 may be part of a backplane, which can also comprise an electric circuit. That is, backplane comprising second electrode layer 105 may be used in Step 7 of the method of manufacture of electro-optic device 500.

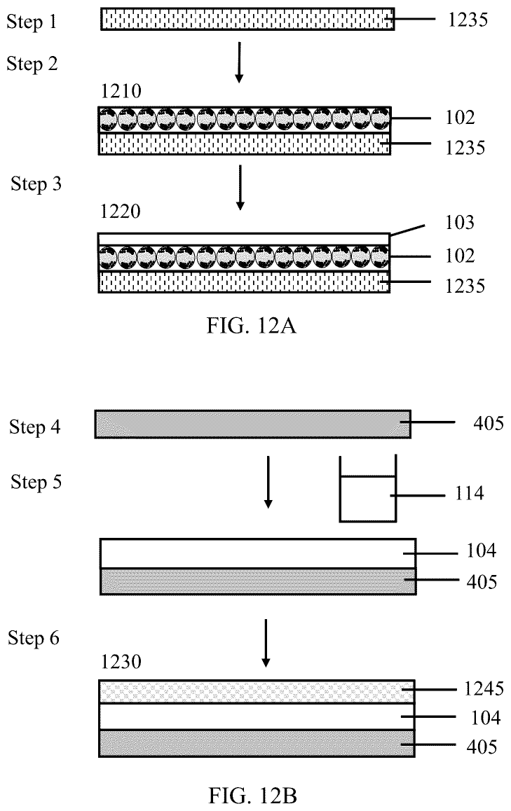

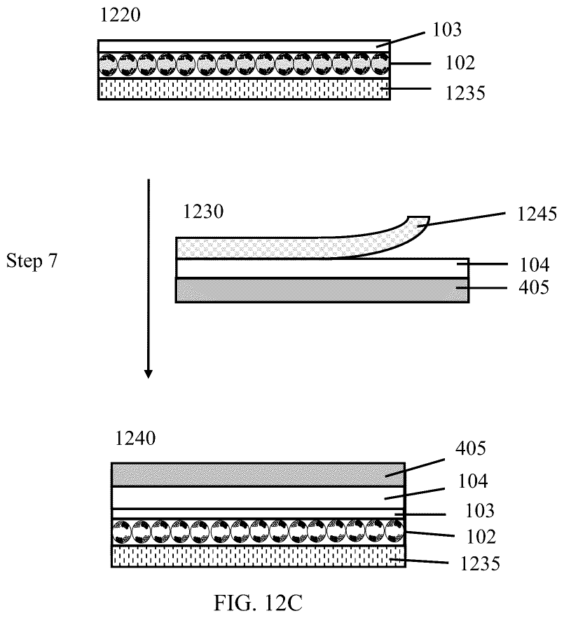

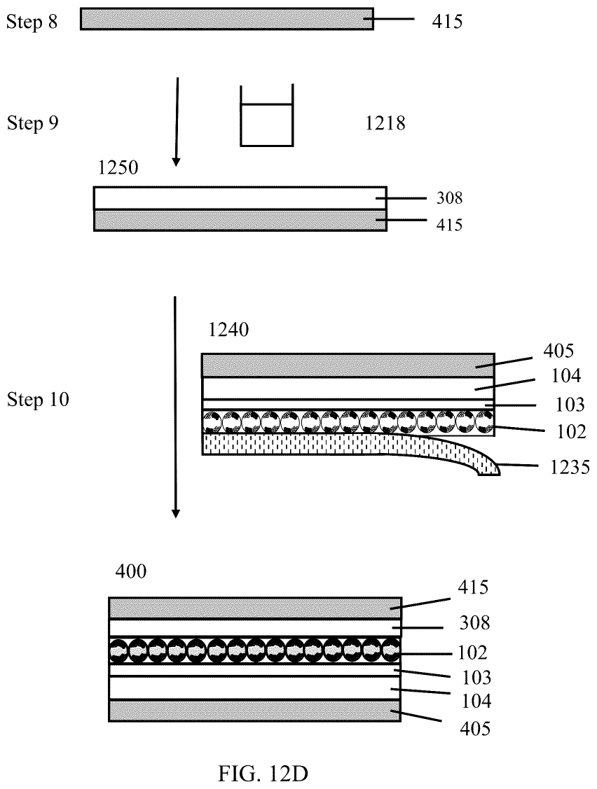

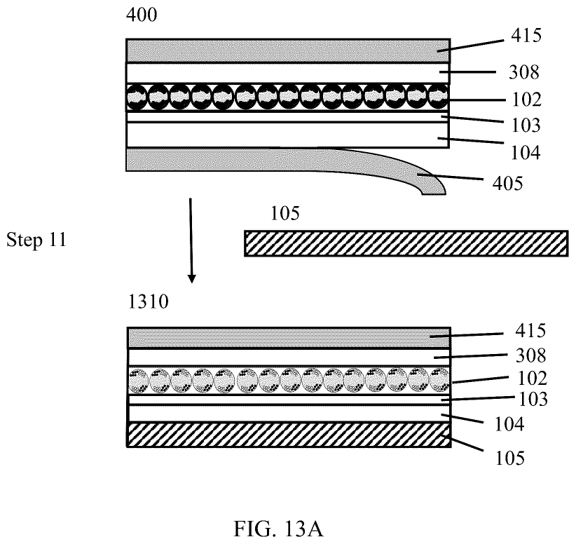

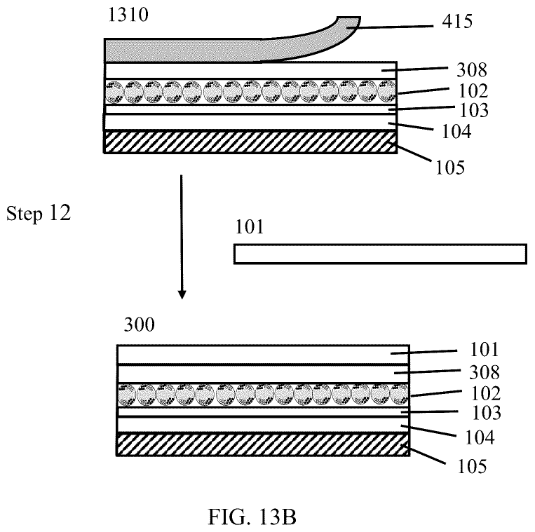

FIGS. 12A, 12B, 12C, 12D, 13A, and 13B summarize an example of a method of manufacture of type (B) electro-optic device 300 via electro-optic assembly 400, which is a double release film (DRF). FIGS. 12A, 12B, 12C, and 12D summarize an example of a method of manufacture of electro-optic assembly 400 (double release film). FIGS. 12A and 12B summarize a method of manufacture of electro-optic device 300 starting from electro-optic assembly 400. FIG. 12A summarize Steps 1 to 3, FIG. 12B summarizes Steps 4 to 6. FIG. 12C summarizes Step 7. FIG. 12D summarizes Steps 8 to 10. FIG. 13A summarizes Step 11 and FIG. 13B summarizes Step 12.

In Step 1 of the method of manufacture of electro-optic device 300, a third release sheet 1235 is provided. In Step 2, an electro-optic material slurry (not shown in FIG. 12A) is coated onto a surface of third release sheet 1235 to form structure 1210. In Step 3, a barrier layer 103 is formed onto the electro-optic material layer 102 of structure 1210 to form electro-optic material film 1220, comprising, in order, third release film 1235, electro-optic material layer 102, and barrier layer 103.

In Step 4, a first release sheet 405 is provided. A first adhesive composition 114 is coated on first release sheet 405. Curing of the coating forms first adhesive layer 104 on first release sheet 405 in Step 5. In Step 6, a fourth release sheet 1245 is attached onto first adhesive layer 104 to form first release assembly 1230.

In Step 7, fourth release sheet 1245 is removed from first release assembly 1230, exposing a surface of first adhesive layer 104, which is connected to barrier layer 103 of electro-optic material film 1220 to form intermediate electro-optic assembly 1240.

In Step 8, a second release film 415 is provided. Onto a surface of second release film 415, a second adhesive composition 1218 is coated and cured to form a second adhesive layer 308 on second release sheet 415 (structure 1250) in Step 9.

In Step 10, third release sheet of intermediate electro-optic assembly 1240 is removed, exposing a surface of electro-optic material layer 102. The exposed surface of electro-optic material layer 102 is connected to second adhesive layer 308 of structure 1250 to form double release film 400 comprising, in order, second release sheet 415, second adhesive layer 308, electro-optic material layer 102, barrier layer 102, first adhesive layer 104 and first release sheet 405.

In Step 11, first release sheet of double release film 400 is removed, exposing a surface of first adhesive layer 104. The exposed surface of first adhesive layer is connected to a second electrode layer 105, second electrode layer 105 comprising a plurality of pixel electrodes, to form an intermediate electro-optic device 1310.

Finally, in Step 12, second release sheet 415 is removed from intermediate electro-optic device 1310, exposing a surface of second adhesive layer 308. The exposed surface of second adhesive layer 308 is connected to a first light transmissive electrode 101, forming electro-optic device 300.

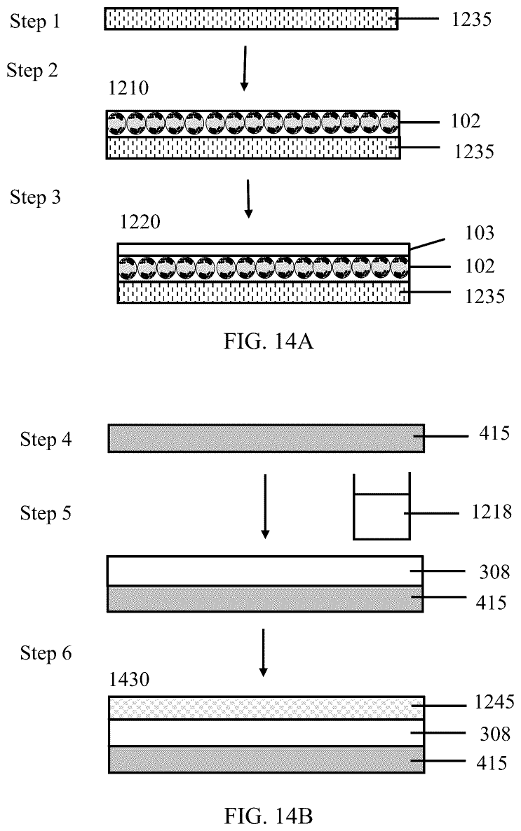

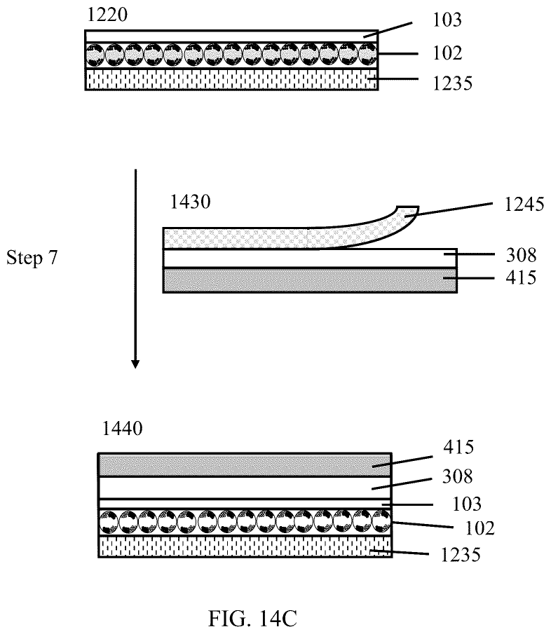

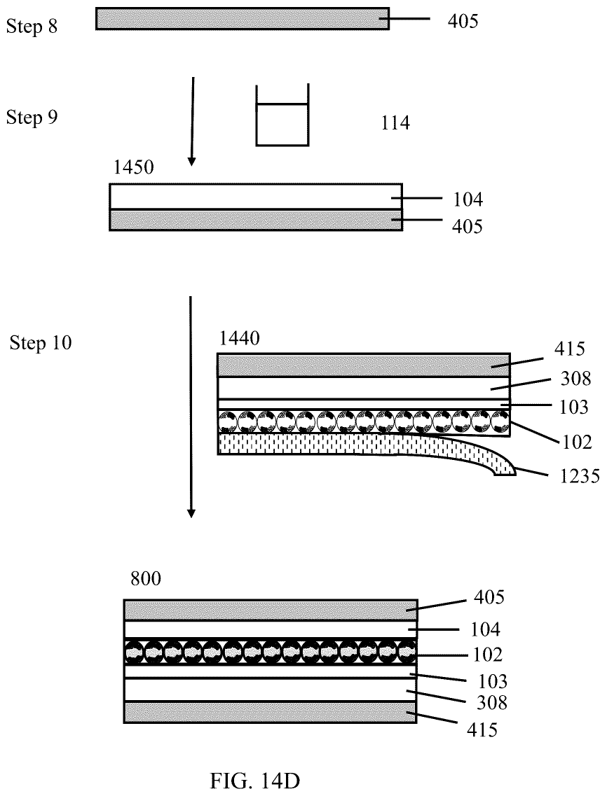

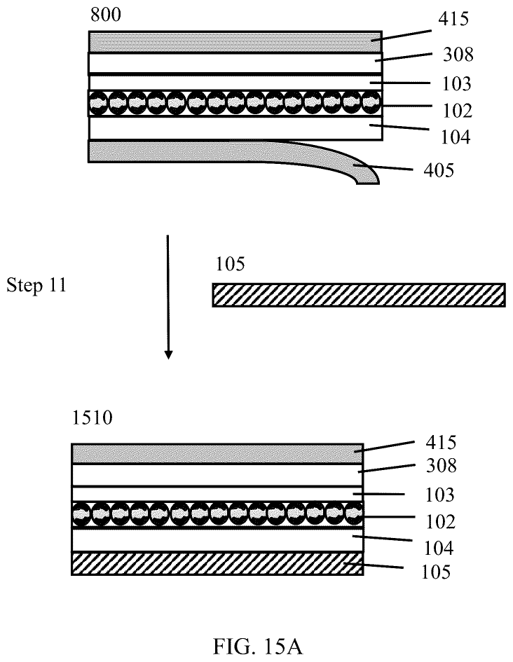

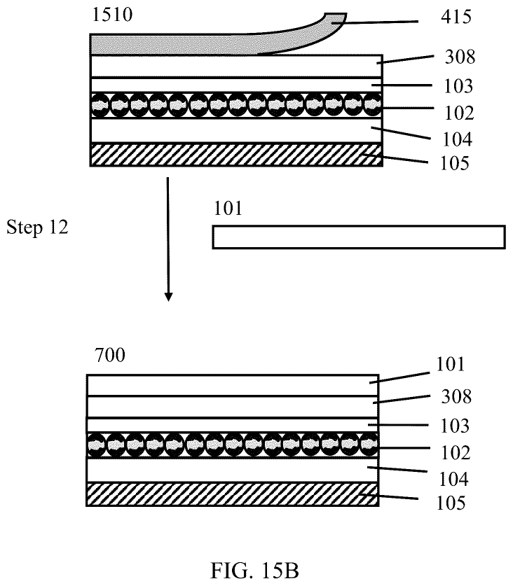

FIGS. 14A, 14B, 14C, 14D, 15A, and 15B summarize an example of a method of manufacture of type (A) electro-optic device 700 via electro-optic assembly 800, which is a double release film (DRF). FIGS. 14A, 14B, 14C, and 14D summarize an example of a method of manufacture of electro-optic assembly 800 (double release film). FIGS. 15A and 15B summarize a method of manufacture of electro-optic device 700 starting from electro-optic assembly 800. FIG. 14A summarize Steps 1 to 3, FIG. 14B summarizes Steps 4 to 6. FIG. 14C summarizes Step 7. FIG. 14D summarizes Steps 8 to 10. FIG. 15A summarizes Step 11 and FIG. 15B summarizes Step 12.

In Step 1 of the method of manufacture of electro-optic device 700, a third release sheet 1235 is provided. In Step 2, an electro-optic material slurry (not shown in FIG. 14A) is coated onto a surface of third release sheet 1235 to form structure 1210. In Step 3, a barrier layer 103 is formed onto the electro-optic material layer 102 of structure 1210 to form electro-optic material film 1220, comprising, in order, third release film 1235, electro-optic material layer 102, and barrier layer 103.

In Step 4, a second release sheet 415 is provided. A second adhesive composition 1218 is coated on second release sheet 415. Curing of the coating forms second adhesive layer 308 on second release sheet 415 in Step 5. In Step 6, a fourth release sheet 1245 is attached onto second adhesive layer 308 to form a second release structure 1430.

In Step 7, fourth release sheet 1245 is removed from second release structure 1430, exposing a surface of second adhesive layer 308, which is connected to barrier layer 103 of electro-optic material film 1220 to form intermediate electro-optic structure 1440.

In Step 8, a first release film 405 is provided. Onto a surface of first release film 405, a second adhesive composition 114 is coated and cured to form a first adhesive layer 104 on first release sheet 405 (structure 1450) in Step 9.

In Step 10, third release sheet of intermediate electro-optic structure 1440 is removed, exposing a surface of electro-optic material layer 102. The exposed surface of electro-optic material layer 102 is connected to first adhesive layer 104 of structure 1450 to form double release sheet 800 comprising, in order, second release sheet 415, second adhesive layer 308, barrier layer 103, electro-optic material layer 102, first adhesive layer 104 and first release sheet 405.

In Step 11, first release sheet of double release sheet 800 is removed, exposing a surface of first adhesive layer 104. The exposed surface of first adhesive layer is connected to a second electrode layer 105, second electrode layer 105 comprising a plurality of pixel electrodes, to form an intermediate electro-optic web 1510.

Finally, in Step 12, second release sheet 415 is removed from intermediate electro-optic web 1510, exposing a surface of second adhesive layer 308. The exposed surface of second adhesive layer 308 is connected to a first light transmissive electrode 101, forming electro-optic device 700.

Adhesive compositions for laminate structures are generally known. They are used to adhere together different layers of the laminate structure. Such adhesive compositions may comprise, for example, hot-melt type adhesives and/or wet-coat adhesives, such as polyurethane-based adhesives. Typically, an electro-optic assembly is a laminate structure and comprises an adhesive layer. The adhesive layer of an electro-optic assembly must meet certain requirements in relation to its mechanical, thermal and electrical properties.

The selection of a lamination adhesive for use in an electro-optic display presents certain problems. Because the lamination adhesive is normally located between the electrodes, which apply the electric field needed to change the electrical state of the electro-optic medium, the electrically conductive properties of the adhesive may significantly affect the electro-optic performance of the display.

The volume resistivity of the lamination adhesive influences the overall voltage drop across the electro-optic medium, which is critical factor in the performance of the medium. The voltage drop across the electro-optic medium is equal to the voltage drop across the electrodes, minus the voltage drop across the lamination adhesive. On one hand, if the resistivity of the adhesive layer is too high, a substantial voltage drop will occur within the adhesive layer, requiring higher voltages between the electrodes to produce a working voltage drop at the electro-optic medium. Increasing the voltage across the electrodes in this manner is undesirable because it increases power consumption and may require the use of more complex and expensive control circuitry to produce and switch the increased voltages. On the other hand, if the resistivity of the adhesive layer is too low, there will be undesirable cross talk between adjacent electrodes (i.e., active matrix electrodes) or the device may simply short out. Also, because the volume resistivity of most materials decreases rapidly with increasing temperature, if the volume resistivity of the adhesive is too low, the performance of the display will vary greatly with temperatures substantially above (or below) room temperature.

For these reasons, there is an optimum range of lamination adhesive resistivity values for use with most electro-optic media, this range varying with the resistivity of the electro-optic medium. The volume resistivities of encapsulated electrophoretic media are typically around 10¹⁰ Ohm·cm, and the resistivities of other electro-optic media are usually of the same order of magnitude. Accordingly, for good electro-optic performance, the volume resistivity of the lamination adhesive is preferably in the range of about 10⁸ Ohm·cm to about 10¹² Ohm·cm, or about 10⁹ Ohm·cm to about 10¹¹ Ohm·cm, at an operating temperature of the display of around 20° C. Preferably, the lamination adhesive will also have a variation of volume resistivity with temperature that is similar to the electro-optic medium itself. The values correspond to measurements after being conditioned for one week at 25° C. and 50% relative humidity.

One way to improve the electro-optic performance of an electro-optic device is the addition of ionic dopants, such as inorganic or organic salts, including ionic liquids, into the adhesive composition. For example, to improve the performance of commercially available polyurethane adhesive compositions, the compositions can be doped with salts or other materials. Non-limiting examples of such a dopant is tetrabutylammonium hexafluorophosphate, butylmethyl imidazolium hexafluorophosphate, and other ionic liquids.

Examples of commercial electro-optic devices include devices comprising two adhesive layers. A typical example is a display comprising a first electrode layer, a second adhesive layer, an electro-optic material layer, a first adhesive layer, and a second electrode layer. The dopant concentration in the second adhesive layer is typically higher than the dopant concentration of in the first adhesive layer. Because of the proximity of the first adhesive layer to the pixel electrodes, high electric conductivity of the first adhesive layer negatively affects display resolution because of increased blooming. However, dopant molecules may diffuse from the second adhesive layer through the various layers of the display to the first adhesive layer, which reduces the image quality. The presence of a barrier layer in the inventive devices disposed adjacent to the electro-optic material prevents such dopant diffusion and improves image quality. Furthermore, in the absence of a barrier layer, dopants and other small molecules may diffuse towards the pixel electrodes and components of the electric circuits of the device, degrading these components and reducing the useful life of the device.

In one embodiment of the present invention (type (A) electro-optic devices), the barrier layer is located between the first light transmissive electrode layer and the electro-optic material layer. In such a device, the barrier layer must be light transmissive. The ability to construct a barrier layer that has small average thickness is critical in this case. Sputtering or vapor deposition methodologies can meet this criterion.

Formation of the barrier layer can be achieved via room temperature radio frequency (RF) sputtering. This methodology can deposit the material used in the barrier layer on the desired surface. The benefit of this methodology is its flexibility to optimize surface morphology and surface roughness of surfaces and its ability to ultra-thin barrier layers. Process parameters, such as RF power, sputtering pressure, and material composition can be varied to achieved the desired thickness and uniformity.

The barrier layer of the present invention may be formed using material selected from the group consisting of metal oxides, metal nitrides, metals and combinations thereof. Non-limited examples of metal oxides include silicon dioxide, aluminum oxide, titanium oxide, and indium-tungsten oxide. Non-limited examples of metal nitrides include aluminum nitride, titanium nitride, and silicon nitride. Non-limited examples of metals include iron, titanium, germanium, vanadium, tungsten, silicon, silver, nickel, niobium, chromium, gold, and mixtures therein.

Light transmissive barrier layer may have average thickness of from 5 nm to 200 nm, from 10 nm to 100 nm, or from 10 nm to 50 nm. Especially in the case of light transmissive barrier layers that comprise metals, the barrier layer may have average thickness of from 5 nm to 30 nm, or from 10 nm to 30 nm.

In another embodiment of the present invention (type (B) electro-optic devices), the barrier layer is located between the second electrode layer and the electro-optic material layer. In such a device, the barrier layer may not be necessary to be light transmissive, although thin layers are preferred in order to enable the operation of the device without a significant increase in the electric potential. In this case, barrier layer may have average thickness of from 5 nm to 1 micrometer, from 8 nm to 500 nm, from 10 nm to 150 nm, from 12 nm to 100 nm, or from 12 nm to 50 nm.

These and other aspects of the present invention will be further appreciated upon consideration of the following Examples, which are intended to illustrate certain particular embodiments of the invention but are not intended to limit its scope, as defined by the claims.

### EXAMPLES

A control device, comprising no barrier layer, and an inventive device, comprising a silicon dioxide barrier layer, were prepared and evaluated. Specifically, the control device was prepared comprising a first light transmissive electrode layer, an electro-optic material layer, and a second electrode layer. The first light transmissive electrode layer comprised polyethylene terephthalate (PET) and indium tin oxide (ITO. The electro-optic material layer comprised microcapsules in a binder. The second electrode layer comprised indium tin oxide (ITO).

Another device was also constructed similar to the control device but comprising a silicon dioxide layer disposed between the first light transmissive electrode layer and the electro-optic material layer.

### Inventive Example 1

Inventive Device Preparation. An electro-optic material slurry was coated onto a first light transmissive (PET/ITO) electrode and partially dried at 55° C. for 10 minutes. The electro-optic material slurry comprised (a) microcapsules including oppositely charged white and black pigment particles in a hydrocarbon liquid, and a polyurethane binder. The assembly was allowed to dry further at 25° C. for 48 hours. After drying, silicon dioxide was deposited onto the electro-optic material layer in vacuum by RF sputtering to form a silicon dioxide barrier layer having average thickness of 10 nm. Finally, Indium tin oxide was sputtered (via RF sputtering) over the silicon dioxide barrier layer to form a 100 nm second electrode layer.

### Comparative Example 2

The Control Device was prepared similarly to Example 1, but without the step of depositing the barrier layer.

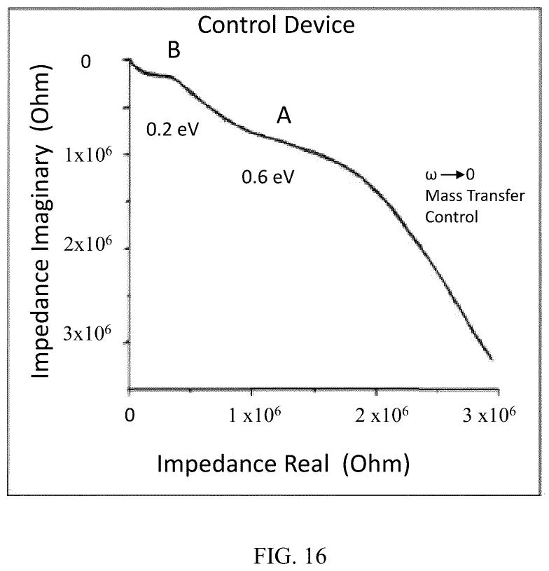

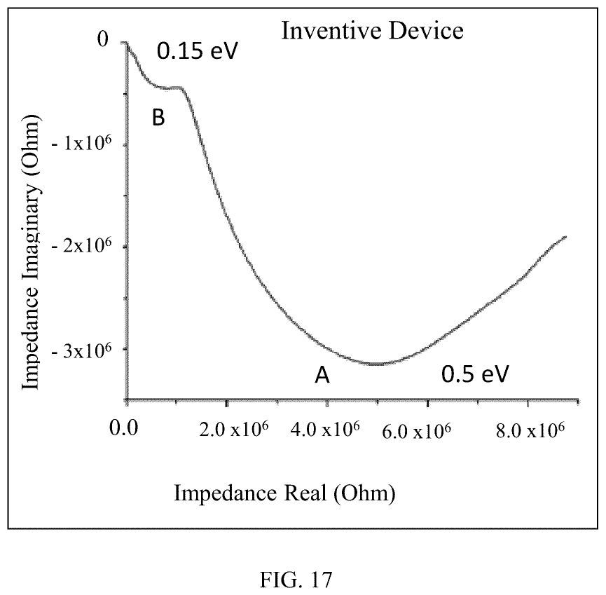

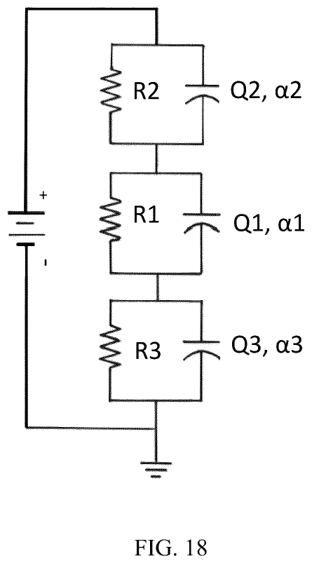

The electrodes of the device of Example 1 were connected with a voltage source and its conductivity was measured via Electrochemical Impedance Spectroscopy (EIS) using Solatron equipment (1296/SI1260) at various temperatures. The measurement process was repeated for the device of Example 2 (Comparative). Electrochemical Impedance Spectra for the two devices were analyzed using equivalent circuit elements and the corresponding Nyquist model. The Nyquist plots are shown in FIG. 16 (Control Device from Comparative Example 2) and FIG. 17 (Inventive Device from Example 2). The equivalent circuit elements that were used for the analysis are provided in FIG. 17, where R is resistance, Q and a are parameters of the constant phase elements of Nyquist model Equations 1 to 4, which are shown below.

### Model Equations

$${Z}_{tot} = {\sum }_{k = 1 .. 3}^{} \frac{1}{\frac{1}{{R}_{k}} + {{Q}_{k} ( j ω )}^{{α}_{k}}} ; \qquad Equation l$$

$$S = {\sum }_{i} [ {( {Z}_{i}^{′} - {Z}^{′} ( {ω}_{i} ) )}^{2} + {( {Z}_{i}^{″} - {Z}^{″} ( {ω}_{i} ) )}^{2} ] ; \qquad Equation 2$$

$${Z}_{i} = {Z}_{i}^{′} + j {Z}_{i}^{″} ; \qquad Equation 3$$

$$σ = \frac{I}{RA} . \qquad Equation 4$$

Z tot of Equation 1 expresses the total electrical impedance of a sample. The fitting of a set of sub-circuit parameters was conducted by minimizing the error function S (from Equation 2). Equation 3 represents the measured data set with Z(ω) being the calculated fit response. Equation 4 represents the calculated response. The ionic conductivity (σ) of the samples was calculated from Equation 4, where R is the bulk resistance of the material, where l is the thickness of the material through which the current flows, and A is the cross-sectional area of the test sample material.

The model identified two different paths of electric current propagation through the sample. The two mechanisms are represented in FIGS. 16 and 17 in regions A and B of the graphs. Calculated conductivities at various temperatures of the regions for the two devices are provided in Tables 1 and 2 below.

TABLE 1
Conductivities from regions A and B for Device of Example 2
(Comparative) at different temperatures.

| B | | A | |
|---|---|---|---|
| Temperature | □ | Temperature | □ |
| Degrees C. | (picoSiemens/cm) | Degrees C. | (picoSiemens/cm) |
| −10 | 206 | −10 | 17 |
| 0 | 206 | 0 | 57 |
| 10 | 301 | 10 | 112 |
| 22 | 451 | 22 | 182 |
| 30 | 543 | 30 | 460 |
| 40 | 870 | 40 | 1900 |

TABLE 2
Conductivities from regions A and B for Device of Example 1 (Inventive)
at different temperatures.

| B | | A | |
|---|---|---|---|
| Temperature | □□ | Temperature | □□ |
| Degrees C. | □picoSiemens/cm) | Degrees C. | □picoSiemens/cm) |
| −10 | 78 | −10 | 9.0 |
| 0 | 139 | 0 | 17.0 |
| 10 | 103 | 10 | 25.8 |
| 22 | 211 | 22 | 93.0 |
| 30 | 198 | 30 | 148 |
| 40 | 233 | 40 | 332 |

The data of Table 1 and 2 show that the device of Example 1 (Inventive) had overall lower conductivity and non-diffusional control regions on its Nyquist plots.

The electro-optic performance of the two devices were evaluated by applying a square waveform with amplitude of 30 V and pulse period of 250 microseconds for 50 seconds to achieve. The state of the color display was determined during the application of the waveform by measuring the lightness of the state (L*). The white state and dark state at the conclusion of the application of the waveform are provided in Table 3.

TABLE 3
Electro-optic Performance of
Devices from Examples 1 and 2.

| | −10° C. | | 10° C. | | 35° C. | |
|---|---|---|---|---|---|---|
| | White | Dark | White | Dark | White | Dark |
| | State | State | State | State | State | State |
| Device of Ex. 2 | 64.5 | 34 | 67 | 31 | 71 | 34 |
| (Comparative) | | | | | | |
| Device of Ex. 1 | 68.5 | 38 | 70 | 30 | 71.5 | 28 |
| (Inventive) | | | | | | |

The data of Table 3 demonstrated that the inventive device (Ex. 1) show better white state (higher L*) in all temperatures, but especially at low temperatures.

Furthermore, during the application of the square waveform, the fluctuation of the brightness (L*) of the white state was measured as the difference between the baseline white state and the peak values of the white state. It was found that the fluctuation of the brightness of the white state of the device of Ex. 2 (Comparative) had an average value of 8 L* units, whereas the fluctuation of the brightness of the white state of the device of Ex. 1 (Inventive) had an average value of 2 L*. This means that the “flashiness” of the device during transition between different states is much more apparent in the device of the comparative device. That is, the Inventive device performed significantly better in terms of flashiness.

The value reported from the colorimeter measurement is the reflectance value L*. The L* has the optic switching performance of electro-optic devices effectiveness (where L* has the usual CIE definition):

$${L}^{*} = 116 {( R / {R}_{0} )}^{1 / 3} - 16 ,$$

where R is the reflectance and R₀ is a standard reflectance value).

1. An electro-optic device being a type (A) or type (B) electro-optic device, the type (A) electro-optic device comprising in order:
a first light transmissive electrode layer;
a barrier layer, the barrier layer being light transmissive;
an electro-optic material layer;
a first adhesive layer; and
a second electrode layer;
the type (B) electro-optic device comprising in order:
a first light transmissive electrode layer;
an electro-optic material layer;
a barrier layer;
a first adhesive layer; and
a second electrode layer;
an electro-optic material layer;
a barrier layer;
a first adhesive layer; and
a second electrode layer;
the electro-optic material layer comprising an electrophoretic medium, the electrophoretic medium including charged pigment particles in a non-polar liquid, the first adhesive layer comprising a first dopant having a first concentration, and the second electrode layer comprising a plurality of pixel electrodes.

2. The electro-optic device of claim 1, wherein the electrophoretic medium is encapsulated in a plurality of microcapsules or in a plurality of microcells, each microcell comprising partition walls, an opening, and a sealing layer, the sealing layer spanning the opening of each microcell.

3. The electro-optic device of claim 2, wherein the electrophoretic medium is encapsulated in a plurality of microcapsules, and wherein the electro-optic device further comprises a second adhesive layer, the second adhesive layer being disposed between the first electrode layer and the barrier layer in the electro-optic device of type (A) or the second adhesive layer being disposed between the barrier layer and the second electrode layer in the electro-optic device of type (B), the second adhesive layer comprising a second dopant having a second concentration.

4. The electro-optic device of claim 3, wherein the first dopant is the same as, or different from the second dopant.

5. The electro-optic device of claim 1, wherein the first concentration of the first dopant in the first adhesive layer is from 50 ppm to 1000 ppm by weight of the first adhesive layer.

6. The electro-optic device of claim 3, wherein the first concentration of the first dopant in the first adhesive layer is lower than the concentration of the second concentration of the second dopant in the second adhesive layer.

7. The electro-optic device of claim 3, wherein the second concentration of the second dopant in the second adhesive layer is from 1000 ppm to 5000 ppm by weight of the first adhesive layer.

8. The electro-optic device of claim 1, wherein the first dopant is an ionic liquid.

9. The electro-optic device of claim 3, wherein the second dopant is an ionic liquid.

10. The electro-optic device of claim 1, wherein the first adhesive layer comprises polyurethane.

11. The electro-optic device of claim 3, wherein the second adhesive layer comprises polyurethane.

12. The electro-optic device of claim 1, wherein the barrier layer comprises a material selected from the group consisting of silicon dioxide, aluminum oxide, aluminum nitride, titanium nitride, titanium oxide, silicon nitride, indium-tungsten oxide, a metal, and mixtures thereof.

13. The electro-optic device of claim 12, wherein the metal is iron, titanium, germanium, vanadium, tungsten, silicon, silver, nickel, niobium, chromium, gold, and mixtures thereof.

14. The electro-optic device of claim 13, wherein the average thickness of the barrier layer is from 5 nm to 30 nm.

15. The electro-optic device of claim 1, wherein the average thickness of the barrier layer is from 5 nm to 1 micrometer.

16. The electro-optic device of claim 1, wherein the average thickness of the barrier layer is from 5 nm to 200 nm.

17. The electro-optic device of claim 1, wherein the barrier layer is formed via sputtering.

18. The electro-optic device of claim 1, wherein the barrier layer is formed via chemical vapor deposition.

19. A method of manufacture of an electro-optic assembly comprising the steps:
providing a first electrode layer having a surface, the first electrode layer comprising a light transmissive electrode;
coating an electro-optic material slurry onto the surface of the first electrode layer, the electro-optic material slurry comprising a plurality of microcapsules and a binder, each of the plurality of the microcapsules comprising charged particles in a non-polar liquid;
curing the binder to form an electro-optic material layer on the surface of the first electrode layer;
forming a barrier layer onto the electro-optic via sputtering or via chemical vapor deposition of a barrier material;
coating a first adhesive composition onto the barrier layer;
curing the adhesive composition, creating a first adhesive layer;
attaching a first release sheet onto the first adhesive layer.

20. A method of manufacture of an electro-optic device, the process comprising the steps:
providing a third release sheet;
coating an electro-optic material slurry onto the third release sheet, the slurry comprising a plurality of microcapsules and a binder, each of the plurality of the microcapsules comprising charged particles in a non-polar liquid;
curing the electro-optic material slurry to form an electro-optic material layer on the third release sheet;
forming a barrier layer onto the electro-optic material layer via sputtering or via chemical vapor deposition of a barrier material to form an electro-optic material film comprising, in order, the barrier layer, the electro-optic material layer, and the third release sheet;
providing a second release sheet;
coating a second adhesive composition onto the second release sheet;
curing the second adhesive composition, creating a second adhesive layer;
attaching a fourth release sheet onto the first adhesive layer to form a second release structure comprising, in order, a fourth release sheet, a second adhesive layer, and a second release sheet;
removing the fourth release sheet from the second release structure, exposing a surface of the second adhesive layer of the second release structure;
connecting the exposed surface of the second adhesive layer onto the barrier layer of the electro-optic material film to form an intermediate electro-optic structure comprising, in order, the second release sheet, the second adhesive layer, the barrier layer, the electro-optic material layer, and the third release sheet;
providing a first release sheet,
coating a first adhesive composition onto the first release sheet;
curing the first adhesive composition, creating a first adhesive layer, to form a first release structure comprising the first adhesive layer and the first release sheet;
removing the third release sheet from the intermediate electro-optic structure to expose a surface of the electro-optic material layer;
connecting the exposed surface of the electro-optic material layer onto the first adhesive layer of the first release structure, to form a double release sheet;
providing a second electrode;
removing the first release sheet of the double release sheet to expose a surface of the first adhesive layer;
connecting the exposed surface of the first adhesive layer with the second electrode to form an intermediate electro-optic web;
providing a first light transmissive electrode;
removing the second release sheet of the intermediate electro-optic web, exposing a surface of the second adhesive layer;
connecting the exposed surface of the second adhesive layer with the first light transmissive electrode.
